(19) United States
(12) Patent Application Publication
(10) Pub. No.: US 2005/0273386 A1
(43) Pub. Date: Dec. 8, 2005

(54) Creating customer bonus rule

(76) Inventor: Jens Weidner, Leimen (DE)

Correspondence Address: FISH & RICHARDSON, P.C., PO BOX 1022, MINNEAPOLIS, MN, 55440-1022, US

(21) Appl. No.: 10/861,759

(22) Filed: Jun. 4, 2004

(51) Int. Cl. G06F 17/60

(52) U.S. Cl. 705/14

(57) ABSTRACT

A method of creating a customer bonus rule to be applied during a marketing campaign may comprise receiving first information in a marketing campaign design tool. The first information may define a marketing campaign that can be performed in a computer system. Foreseen customer responses to the defined marketing campaign may include a predefined customer transaction. The method comprises receiving second information in the marketing campaign design tool. The second information may define a customer bonus rule that instructs the computer system to award a customer bonus upon detecting the predefined customer transaction during the defined marketing campaign. The method may comprise storing the defined customer bonus rule in the computer system such that the defined customer bonus rule can be applied during the defined marketing campaign.

### TECHNICAL FIELD

This description relates to creating a customer bonus rule to be applied during execution of a marketing campaign in a computer system.

### BACKGROUND

Some computer systems for customer relationship management (CRM) allow a user to create marketing campaigns for an organization's business. Such a marketing campaign can include any of a great variety of campaign activities performed through one or more marketing channels. For example, the campaign can include sending a predefined message to a target group by email or regular mail. As another example, the campaign can involve contacting the target group by telephone (e.g., through a call center) or through personal visits by sales representatives. As yet another example, the campaign may include an advertising campaign for specific goods or services. Marketing campaigns are often created by members of the organization's marketing department. Accordingly, it may be an advantage if the software program for designing the campaign is easy to use, particularly for a person who is not trained as a software developer.

Moreover, for every campaign there may be one or more foreseen customer responses. That is, the person designing the campaign typically envisions that the campaign will cause customers to buy specific goods or services from the organization, or take another definitive action that the organization can track.

Many organizations award bonus points to customers based on their amounts of purchases. For example, airline companies award “frequent flier miles” or equivalent bonuses that customers later can redeem as payment for additional services. Such customer bonus systems typically are implemented in a separate computer software program. That is, the separate program may include one or more customer bonus rules that at some time is applied to information regarding customer transactions. Sometimes, the customer transaction for which a bonus is awarded is one of the foreseen customer responses to a marketing campaign.

There may be problems, however, with existing customer bonus programs. They may be difficult to use for a person without expert software knowledge, particularly if the user must have specific programming skills to formulate and implement the customer bonus rules. Existing systems may lack a user-friendly graphical user interface (GUI) for creating campaigns and related bonus rules.

For example, a marketing department-employee that creates a campaign may wish to implement a bonus rule to reward those customer transactions that are among the foreseen responses to the marketing campaign. In existing systems, the marketing department-employee may have to learn both the campaign planning software program and the bonus points software program.

Also, existing systems may lack efficiency and flexibility in applying bonus rules to customer transactions. For example, such systems may require batch-wise processing, meaning that rules are only applied at certain time intervals, which may cause a delay from when the transaction takes place until the bonus is awarded. Particularly, existing systems may not be well suited to award customer bonuses for retail transactions—that is, applying customer bonus rule(s) to a large volume of customer transactions reported from a point-of-sale.

### SUMMARY

The invention relates to creating a customer bonus rule.

In a first general aspect, a method of creating a customer bonus rule to be applied during a marketing campaign comprises receiving first information in a marketing campaign design tool. The first information defines a marketing campaign that can be performed in a computer system. Foreseen customer responses to the defined marketing campaign include a predefined customer transaction. The method comprises receiving second information in the marketing campaign design tool. The second information defines a customer bonus rule that instructs the computer system to award a customer bonus upon detecting the predefined customer transaction during the defined marketing campaign. The method comprises storing the defined customer bonus rule in the computer system such that the defined customer bonus rule can be applied during the defined marketing campaign.

In selected embodiments, the computer system includes several customer bonus rules, and the several customer bonus rules are applied as the computer system detects customer transactions. The defined customer bonus rule is created to update the several customer bonus rules, and the defined customer bonus rule can be applied upon being stored in the computer system.

In some embodiments, a vendor is associated with the defined customer bonus rule. The predefined customer transaction may include a vendor identifier and it may be determined whether the vendor identifier matches the associated vendor.

In some embodiments, the computer system receives customer transactions in a data repository and the predefined customer transaction is detected in the data repository. The customer bonus may be stored in the data repository upon detecting the predefined customer transaction. The marketing campaign design tool may exist in a design computer system, and the stored customer bonus may be transferred to the design computer system. The stored customer bonus may be added to any existing customer bonus stored in the design computer system for a total customer bonus, and the total customer bonus may be stored in the design computer system. If the total customer bonus meets a condition, the marketing campaign design tool may be caused to launch a response campaign.

In some embodiments, the data repository includes a rule object for the defined customer bonus rule, a transaction object for the predefined customer transaction, and a bonus object for the stored customer bonus. A marketing campaign identifier for the defined marketing campaign may be associated with the bonus object. The data repository may include several bonus objects associated with the marketing campaign identifier, and the several bonus objects may be accessed to determine a total bonus for the marketing campaign.

In some embodiments, the system applies a time limit for the defined marketing campaign as a validity period for the defined customer bonus rule.

In a second general aspect, a computer-based marketing campaign design tool comprises:
a marketing campaign creation module for defining a marketing campaign that can be performed in a computer system, foreseen customer responses to the defined marketing campaign including a predefined customer transaction; and
a customer bonus rule creation module for defining a customer bonus rule that instructs the computer system to award a customer bonus upon detecting the predefined customer transaction during the defined marketing campaign.

Advantages of the systems and techniques described herein may include any or all of the following: improving creation of customer bonus rules; improving application of customer bonus rules; providing a more user-friendly GUI; improving computerized marketing campaigns.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1A shows a marketing campaign being defined in a GUI;

FIG. 1B shows a customer bonus rule being defined in the GUI;

FIG. 2 is a block diagram of a computer system in which marketing campaigns can be created or executed;

FIGS. 3A and 3B show a flow chart of an embodiment of an inventive method; and

FIG. 4 shows a block diagram of a general computer system.

Like reference numerals in the various drawings indicate like elements.

### DETAILED DESCRIPTION

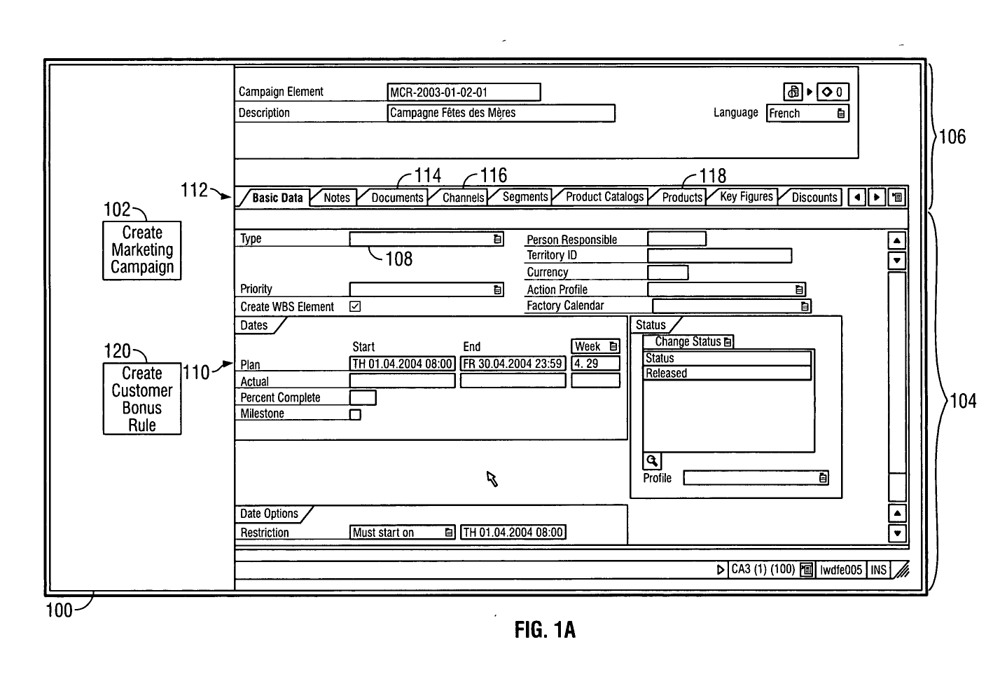

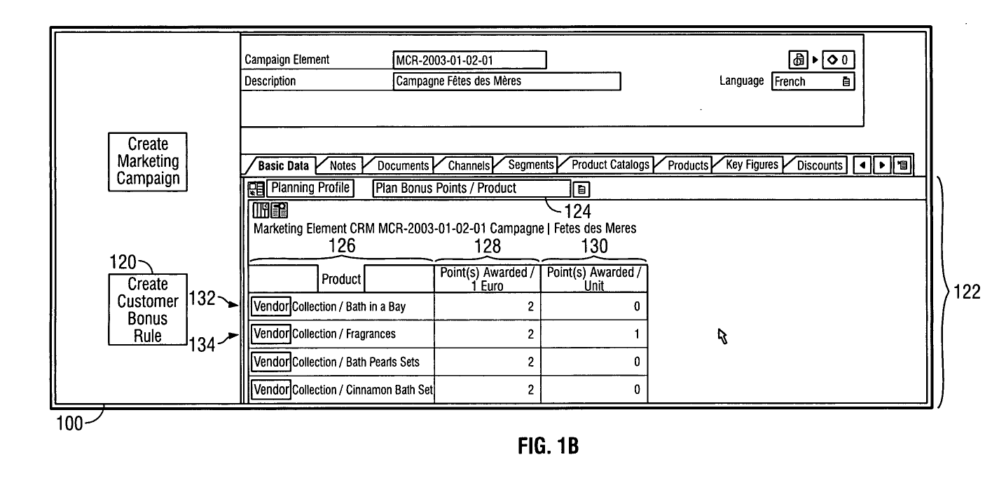

FIGS. 1A and 1B show a GUI 100 that can be generated by an embodiment of an inventive marketing campaign design tool. The GUI 100 lets a user create both a marketing campaign and a customer bonus rule that can be applied during the campaign. In FIG. 1A, the user has selected a Create Marketing Campaign input control 102, and the GUI therefore presents a campaign definition area 104. For example, the area 104 may be used to define each of several successive activities, or “elements,” of the campaign. General information about the whole campaign, such as its name, may be entered in a campaign header area 106.

The user can enter specific campaign information in area 104, such as a campaign type in field 108 and campaign time limits in fields 110. This corresponds to “basic data” for the campaign as indicated by the selected tab in tab strip 112. The user can select another one of the tabs to enter additional campaign characteristics such as defining campaign documents (tab 114), specifying the marketing channel(s) to be used (tab 116), or specifying the product(s) that the campaign relates to (tab 118). Thus, the GUI 100 lets the user enter information that defines the marketing campaign. This information is received and stored by a computer system that generates the GUI. When the campaign has been created, the system can launch the campaign (for example on a start date specified in fields 110), or the system can transfer the created campaign to a different system for launching.

The user may also want to create a customer bonus rule that can be applied during the campaign. For example, assume that the defined marketing campaign relates to a certain product. The user expects that some customers will purchase the product in response to the campaign. Accordingly, a purchase of that product is one of perhaps several foreseen customer responses to the campaign. It is noted that one does not always know whether the purchasing customer is in fact responding to a specific campaign or simply decides to buy the product anyway. However, because a customer bonus rule typically awards its bonus regardless of the customer's reasons for purchase, it may be assumed that every customer transaction that meets the condition(s) set by the bonus rule is a response to the campaign.

To begin creating a customer bonus rule, the user can select a Create Customer Bonus Rule input control 120 in the marketing campaign design tool. In response, a rule definition area 122 is presented in the GUI 100 as shown in FIG. 1B. In a rule type selection field 124 the user can select which type of bonus rule is being created. Here, the field 124 indicates that the created rule(s) will award bonus points based on a purchased product. Other available selections in field 124 may create rules that award bonus points based on other types of customer transaction. For example, a rule may award a bonus upon the customer accumulating a specific amount of purchases, wherein the bonus rule is triggered by the particular transaction that causes the condition set by the rule to be met.

The user can enter information in the area 122 to define one or more new customer bonus rules. The area 122 includes a product identification column 126 where the user can enter the name of one or more product that the computer system recognizes. The area 122 includes one or more bonus award column (128, 130) that specifies the size of bonus awarded. Here, the user has created bonus rules for four separate products. For example, the user has created a bonus rule 132 for customer purchases of a product called “Bath in a Bay” that is part of a “Vendor Collection”. In column 128, the user has entered a “2” for the rule 132, which means that the customer will be awarded two bonus points for each Euro that the customer spends on this product. The column 130 contains a zero for the rule 132, which means that the customer is not awarded any bonus point for purchasing a specific unit of this product. In contrast, the next rule entry, customer bonus rule 134, contains a “1” in column 130, meaning that the customer earns one bonus point for purchasing a specific unit of this product. In this example, the rule 134 awards two bonus points per Euro spent on the product, analogous to the rule 132. Thus, the GUI 100 lets the user enter information that defines one or more customer bonus rules. This information is received and stored by the computer system that generates the GUI. The system may thereafter apply the defined customer bonus rule or transfer the created customer bonus rule to be applied in a different system. The duration of the defined customer bonus rule may be tied to the marketing campaign to which the rule relates. For example, the system can assign the campaign time limits entered in the fields 110 as validity dates for the defined rule.

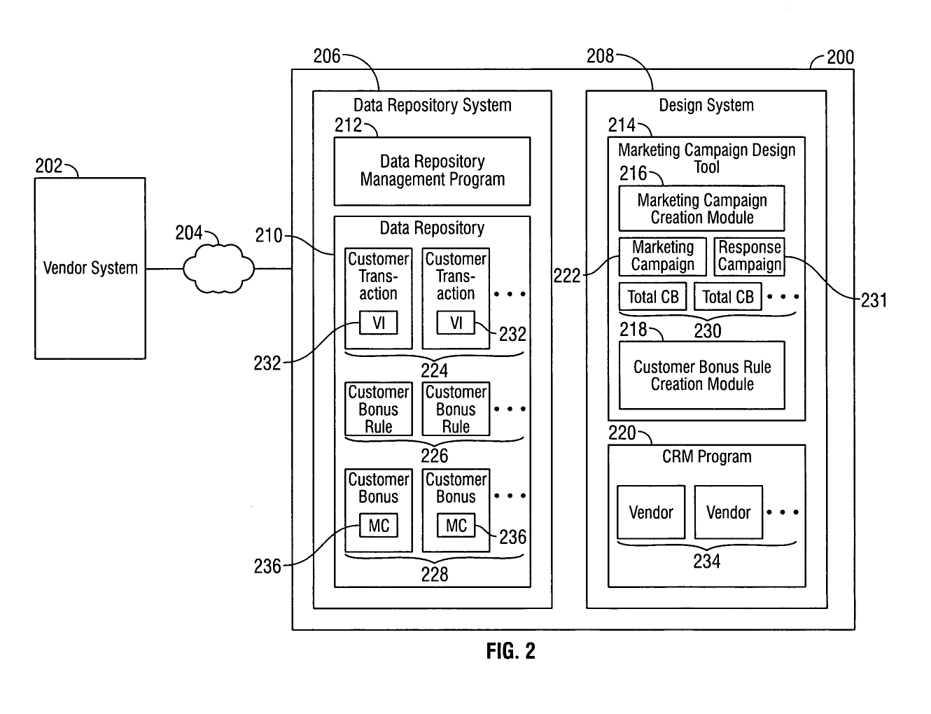

An example of applying a customer bonus rule during a marketing campaign will now be described with reference also to FIG. 2. A system 200 may be used for defining and launching marketing campaigns, and for defining and applying customer business rules. The system 200 is connected to one or more vendor systems 202 through any kind of network 204. The vendor system 202 is where customer transactions may take place. The network connection allows the system 200 to reach the vendor(s) with the defined marketing campaigns, and to receive information from the vendor(s) documenting the customer transactions. The vendor operating the system 202 may be a retail business that uses the computer system to manage and document all of its customer transactions. Accordingly, the system 202 may include suitable software for handling sales transactions, to name just one example.

The system 200 may include a data repository (DR) system 206 and a design system 208. The DR system 206 may include a DR 210 managed by a DR management program 212. The DR 210 may be used as a knowledge storage from which detailed data about the system 200 can be extracted through advanced search operations supported by the DR management program 212. In some implementations, the DR system may include products from the “Data Warehouse” family of products available from SAP AG located in Walldorf (Baden), Germany.

The DR 210 receives the customer transactions reported by the vendor. The vendor may report customer transactions to the DR 210 on a real time basis or on-the-fly, at regular intervals, or at arbitrary times. The system 200 applies the customer bonus rule(s) to the customer transactions and awards bonus(es) accordingly. The awarded bonus(es) may be stored in the DR 210.

The design system 208 may have stored therein marketing campaign design tool (MCDT) 214, which may be used for defining marketing campaigns and bonus rules, for example as described above with reference to FIGS. 1A and B. The MCDT may include a marketing campaign creation module 216 that generates the campaign definition area 104 that is to be presented in the GUI 100. The MCDT may include a customer bonus rule creation module 218 that generates the rule definition area 122. The design system 208 also may have stored therein a CRM program 220 that can perform conventional CRM functions in the system 200. In such implementations, the design system 208 may also be considered a “CRM system”.

Thus, the MCDT can be used to define a marketing campaign 222, which can be stored in the design system 208. At a predefined time, such as that specified in the fields 110, the system 200 launches the campaign 222. The campaign may involve approaching customers with product offers or initiating product-specific advertising, to name just two examples. During the campaign, the vendor system 202 may register customer transactions and forward them to the system 200.

The DR system 206, in turn, may create one or more customer transaction objects 224 that represent the customer transactions. The MCDT may provide the defined customer bonus rule(s) so that the DR system can apply the rule(s) to the transactions that are stored in the DR. For example, the DR system may create and store one or more customer bonus rule objects 226 that incorporate the defined rule(s). If a rule specifies that a bonus should be awarded to the customer whose transaction the rule is applied to, the DR system 206 may create and store one or more customer bonus objects 228. In some implementations, one or more of the objects 224, 226 and 228 can be implemented as an InfoCube object. The InfoCube technology is developed by SAP AG located in Walldorf (Baden), Germany.

Customer transactions in a retail environment may take place at essentially any time of day and with varying intensity. The system 200 therefore may be able to process customer transactions in real-time as they are received, or “on-the-fly”. One advantage of this is that customers qualifying for bonuses, who typically want the bonuses awarded without significant delay, can receive bonuses more expediently. Moreover, changes in the bonus rules can be applied upon the amended or new rule being stored in the DR system. This may allow one to see the effect of applying the changed rule much sooner, because the rule is being applied to a “stream” of customer transactions as opposed to a static batch of customer transactions that have been collected over a period of time.

Periodically, or at arbitrary times, the awarded customer bonuses may be forwarded to the design system 208. If there is already stored in the design system an existing bonus for the customer, the forwarded customer bonus may be added to it, forming one or more total customer bonus (CB) 230. The total CB 230 may be used in designing an additional marketing campaign. For example, customers whose total bonus exceeds a specified amount may be targeted with a response campaign 231.

As another example, it may be desirable to track which vendor is responsible for the received customer transactions. Some or all of the customer transactions may include a vendor identifier (VI) 232 for the responsible vendor. Moreover, one or more of the customer bonus rules may be associated with a particular vendor in the system 200. For example, when defining the bonus rule in the GUI 100 the user may create an association between the rule and one or more vendor objects 234 that may exist in the CRM program 220. Upon awarding bonuses to specific customers, then, the system 200 can determine whether the VI 232 in the customer transaction matches the vendor object(s) 234 with which the customer bonus rule is associated. The system 200 may use this determination to tally the awarded bonuses for individual vendors and issue vouchers or equivalent rewards to vendors who score sufficiently high numbers of bonuses. The act of rewarding the vendors may take place in form of launching response campaign 231.

As yet another example, it may be desirable to track which campaign produces specific bonus awards. When defining the customer bonus rule, the user may create an association between it and the marketing campaign such that the DR system, in turn, can tag the awarded bonus(es) with an identifier for the campaign. For example, when the DR system applies a bonus rule to a transaction and determines that a bonus should be awarded, it may associate with the bonus(es) a marketing campaign (MC) identifier 236 for the bonus rule's campaign. The system can access the awarded customer bonus objects and determine, for those having a MC 236, which marketing campaign they are associated with. Accordingly, the system can determine a total bonus for a specific marketing campaign. Such a total bonus may indicate how successful a campaign is.

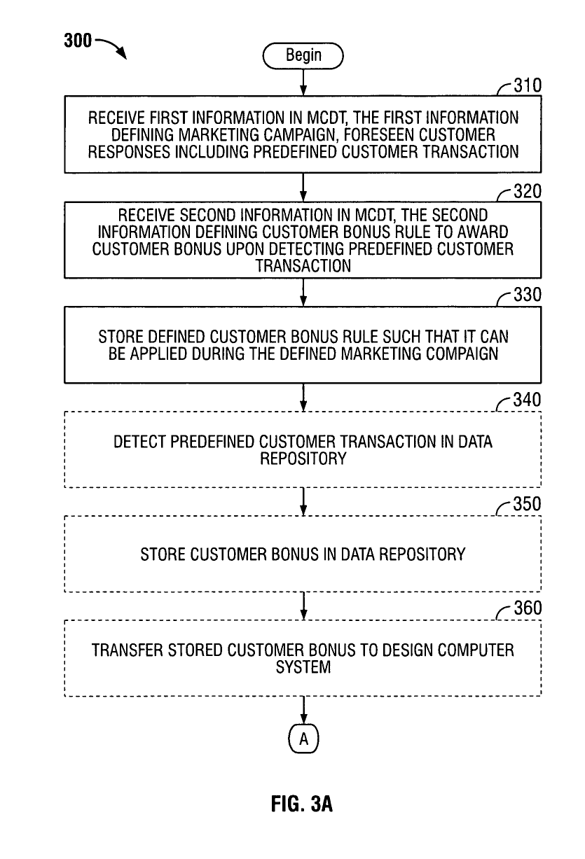

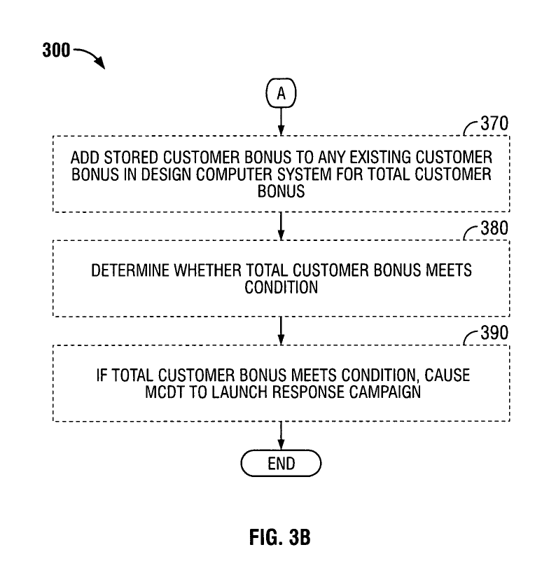

FIGS. 3A and 3B are a flow chart of a method 300. The method 300 may be performed in the system 200. For example, a computer program product may include instructions that cause a processor to perform operations comprising the steps of the method 300. The method 300 includes the following steps:

Receiving, in step 310, first information in a marketing campaign design tool, the first information defining a marketing campaign that can be performed in a computer system. Foreseen customer responses to the defined marketing campaign include a predefined customer transaction. For example, the user may enter the information that defines the marketing campaign 222 using the campaign definition area 104, for receipt by the system 200. One or more of the customer transactions 224 may be foreseen responses to the campaign 222.

Receiving, in step 320, second information in the marketing campaign design tool, the second information defining a customer bonus rule that instructs the computer system to award a customer bonus upon detecting the predefined customer transaction during the defined marketing campaign. For example, the user may enter the information that defines the customer bonus rule 226 using the rule definition area 122, for receipt by the system 200.

Storing, in step 330, the defined customer bonus rule in the computer system such that the defined customer bonus rule can be applied during the defined marketing campaign. For example, the customer bonus rule 226 may be stored in the DR 210 where it can be applied to customer transactions 224 during the campaign 222.

Detecting, in optional step 340, the predefined customer transaction in a data repository. For example, the system 200 may receive multiple customer transactions 224 in the DR 210, and detect the predefined customer transaction among them.

Storing, in optional step 350, the customer bonus in the data repository upon detecting the predefined customer transaction. For example, the system 200 can store the customer bonus 228 in the DR 210 upon detecting the predefined customer transaction 224.

Transferring, in optional step 360, the stored customer bonus to a design computer system where the marketing campaign design tool is located. For example, the system 200 can transfer the customer bonus from customer bonus object(s) 236 to the design system 208 where the MCDT 214 may be located.

Adding, in optional step 370, the stored customer bonus to any existing customer bonus stored in the design computer system for a total customer bonus. For example, the system 200 may add the transferred customer bonus to existing bonus to form the total CB 230 for one or more customers. The total CB 230 may be stored in the design system 208.

Determining, in optional step 380 and in the design computer system, whether the total customer bonus meets a condition. For example, it can be determined whether the total customer bonus meets a condition for targeting the customer in a future marketing campaign. As another example, it can be determined whether the total customer bonus qualifies the vendor for a reward.

If the total customer bonus meets the condition, causing the marketing campaign design tool, in optional step 390, to launch a response campaign. For example, the system 200 can launch the response campaign 231 toward a target group including any customer whose bonus meets the condition. As another example, the system 200 can launch the response campaign 231 to reward a vendor whose total customer bonus meets the condition.

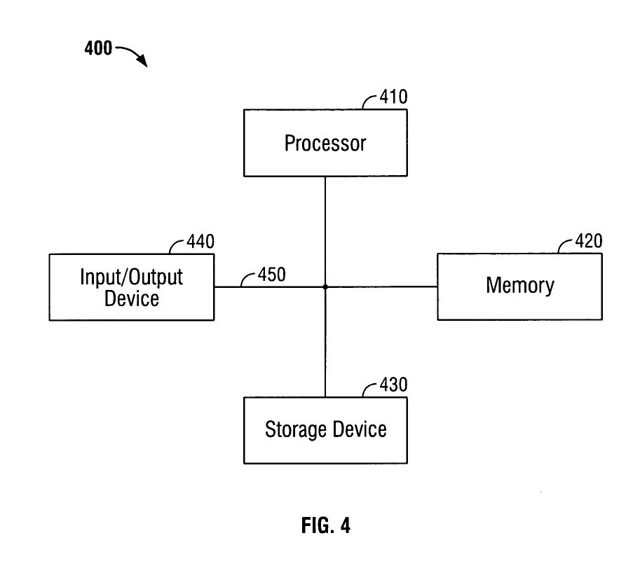

FIG. 4 is a block diagram of a computer system 400 that can be used in the operations described above, according to one embodiment. The system 400 includes a processor 410, a memory 420, a storage device 430 and an input/output device 440. Each of the components 410, 420, 430 and 440 are interconnected using a system bus 450. The processor 410 is capable of processing instructions for execution within the system 400. In one embodiment, the processor 410 is a single-threaded processor. In another embodiment, the processor 410 is a multi-threaded processor. The processor 410 is capable of processing instructions stored in the memory 420 or on the storage device 430 to display graphical information for a user interface on the input/output device 440.

The memory 420 stores information within the system 400. In one embodiment, the memory 420 is a computer-readable medium. In one embodiment, the memory 420 is a volatile memory unit. In another embodiment, the memory 420 is a non-volatile memory unit.

The storage device 430 is capable of providing mass storage for the system 400. In one embodiment, the storage device 430 is a computer-readable medium. In various different embodiments, the storage device 430 may be a floppy disk device, a hard disk device, an optical disk device, or a tape device.

The input/output device 440 provides input/output operations for the system 400. In one embodiment, the input/output device 440 includes a keyboard and/or pointing device. In some embodiments, the input/output device 440 includes a display unit for displaying graphical user interfaces. For example, the input/output device 440 may generate the GUI 100.

The invention can be implemented in digital electronic circuitry, or in computer hardware, firmware, software, or in combinations of them. Apparatus of the invention can be implemented in a computer program product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the invention can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The invention can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. Accordingly, other embodiments are within the scope of the following claims.

1. A method of creating a customer bonus rule to be applied during a marketing campaign, the method comprising:
receiving first information in a marketing campaign design tool, the first information defining a marketing campaign that can be performed in a computer system, foreseen customer responses to the defined marketing campaign including a predefined customer transaction;
receiving second information in the marketing campaign design tool, the second information defining a customer bonus rule that instructs the computer system to award a customer bonus upon detecting the predefined customer transaction during the defined marketing campaign; and
storing the defined customer bonus rule in the computer system such that the defined customer bonus rule can be applied during the defined marketing campaign.

2. The method of claim 1, wherein the computer system includes several customer bonus rules, and wherein the several customer bonus rules are applied as the computer system detects customer transactions.

3. The method of claim 2, wherein the defined customer bonus rule is created to update the several customer bonus rules, and wherein the defined customer bonus rule can be applied upon being stored in the computer system.

4. The method of claim 1, wherein the predefined customer transaction is one that causes a condition to be met, the condition being specified by the defined customer bonus rule.

5. The method of claim 1, further comprising associating a vendor with the defined customer bonus rule.

6. The method of claim 5, wherein the predefined customer transaction includes a vendor identifier, further comprising determining whether the vendor identifier matches the associated vendor.

7. The method of claim 1, wherein the computer system receives customer transactions in a data repository, further comprising detecting the predefined customer transaction in the data repository.

8. The method of claim 7, further comprising storing the customer bonus in the data repository upon detecting the predefined customer transaction.

9. The method of claim 8, wherein the marketing campaign design tool exists in a design computer system, further comprising transferring the stored customer bonus to the design computer system.

10. The method of claim 9, further comprising adding the stored customer bonus to any existing customer bonus stored in the design computer system for a total customer bonus, and storing the total customer bonus in the design computer system.

11. The method of claim 10, further comprising determining, in the design computer system, whether the total customer bonus meets a condition.

12. The method of claim 11, further comprising causing the marketing campaign design tool to launch a response campaign if the total customer bonus meets the condition.

13. The method of claim 8, wherein the data repository includes a rule object for the defined customer bonus rule, a transaction object for the predefined customer transaction, and a bonus object for the stored customer bonus.

14. The method of claim 13, wherein the computer system accesses the rule object upon detecting the transaction object and creates the bonus object.

15. The method of claim 13, wherein the marketing campaign design tool exists in a design computer system that includes a vendor object associated with the defined customer bonus rule.

16. The method of claim 15, wherein the transaction object includes a vendor identifier, further comprising determining whether the vendor identifier matches the associated vendor object.

17. The method of claim 13, further comprising associating a marketing campaign identifier for the defined marketing campaign with the bonus object.

18. The method of claim 17, wherein the data repository includes several bonus objects associated with the marketing campaign identifier, further comprising accessing the several bonus objects to determine a total bonus for the marketing campaign.

19. The method of claim 1, further comprising applying a time limit for the defined marketing campaign as a validity period for the defined customer bonus rule.

20. A computer program product tangibly embodied in an information carrier, the computer program product including instructions that, when executed, cause a processor to perform operations comprising:
receive first information in a marketing campaign design tool, the first information defining a marketing campaign that can be performed in a computer system, foreseen customer responses to the defined marketing campaign including a predefined customer transaction;
receive second information in the marketing campaign design tool, the second information defining a customer bonus rule that instructs the computer system to award a customer bonus upon detecting the predefined customer transaction during the defined marketing campaign; and
store the defined customer bonus rule in the computer system such that the defined customer bonus rule can be applied during the defined marketing campaign.

21. A computer-based marketing campaign design tool comprising:
a marketing campaign creation module for defining a marketing campaign that can be performed in a computer system, foreseen customer responses to the defined marketing campaign including a predefined customer transaction; and
a customer bonus rule creation module for defining a customer bonus rule that instructs the computer system to award a customer bonus upon detecting the predefined customer transaction during the defined marketing campaign.

22. The computer-based marketing campaign tool of claim 21, wherein the marketing campaign and the customer bonus rule are created using the computer-based marketing campaign tool.

23. The computer-based marketing campaign tool of claim 21, wherein a vendor can be associated with the defined marketing campaign and wherein the defined customer bonus rule further instructs the computer system to determine whether the detected predefined customer transaction includes a vendor identifier that matches the associated vendor.

24. The computer-based marketing campaign tool of claim 21, wherein the defined customer rule further instructs the computer system to associate with the customer bonus a marketing campaign identifier for the defined marketing campaign.

25. The computer-based marketing campaign tool of claim 21, configured to receive the awarded customer bonus from the computer system and to launch a response campaign if the customer bonus meets a condition.
